(19) United States
(12) Patent Application Publication
(10) Pub. No.: US 2006/0210954 A1
(43) Pub. Date: Sep. 21, 2006

(54) Apparatus and methods for teaching young children basics of arithmetic

(76) Inventor: Phillip L. Prime, Indianapolis, IN (US)

Correspondence Address: Penrose Lucas Albright, Esq.;MASON, MASON & ALBRIGHT, 2306 South Eads Street, P.O. Box 2246, Arlington, VA, 22202, US

(21) Appl. No.: 11/348,016

(22) Filed: Apr. 26, 2006

Related U.S. Application Data
(60) Provisional application No. 60/650,139, filed on Feb. 7, 2005.

(51) Int. Cl. G09B 23/02

(52) U.S. Cl. 434/188

(57) ABSTRACT

Educational paraphernalia and methods for using same to introduce and teach very young children the basics of arithmetic commencing with first the recognition of individual numbers, then counting, followed by the rudiments of addition, subtraction, multiplication, division and fractions, including the recognition of coins and utilizing them for making proper payments and change.

### RELATED APPLICATION

This Application is based on my Provisional Application Ser. No. 60/650,139, filed Feb. 7, 2006.

### FIELD OF THE INVENTION

The present invention relates to educational paraphernalia and methods for using same to introduce and teach very young children elements of arithmetic from the recognition of individual numbers and counting to the rudiments of addition, subtraction, multiplication, division and fractions.

### BACKGROUND OF THE INVENTION:

It is a recognized national problem that many children are reaching high school age who are incapable of simple arithmetic computations, a foreboding of extremely limited employment opportunities in their adult lives. Numerous types of apparatus and methods of using same have been proposed in the prior art for teaching the fundamentals of arithmetic to children. However, much of such prior art fails, because of its complexity, to be understood by those who may be innately slower in grasping the concepts that such prior art is otherwise attempting to impart to them. The instant invention is directed primarily to students of this type whereby relatively simple teaching paraphernalia is provided which can be easily manipulated by slow learning children for the purpose of learning the fundamentals of arithmetic and doing so in a manner whereby their instructors can readily ascertain when a child has mastered basic arithmetic fundamentals before proceeding to the next higher learning step. At the same time, the apparatus and methods of the present invention will subconsciously or consciously prepare all students, including those who may be the brightest in the class, for more advanced mathematical concepts such as involve number sets and numerical progressions having a basis other than ten.

### SUMMARY OF THE INVENTION

The first step to teach a child arithmetic is to teach him or her the individual numbers and what they mean, and then, or as the recognition of the number is being mastered, to teach the child how to count from 0 to 10. Once a child learns the skill of counting from 0 to 10, the next step is to advance his or her proficiency to count to 100. When this skill acquired, well known apparatus for receiving the numbers 0 to 100 can be utilized for the child to acquire the skill of counting by various numbers, say by 3's or 5's, both forward and backward, to gain an insight for addition and subtraction as well as multiplication and division. Finally another tabulation table is provided for the use of monetary change, that is pennies, nickels, dimes and quarters, which can be utilized to instruct not only for calculating change, but also for imparting initial skills essential for handling money.

For teaching numbers, small elongate pliable bodies which may be personalized by providing eyes and a mouth are utilized to form the various numerals while at the same time each number is provided a “personality” to go with its name and appearance, whereby the child will learn what each numeral looks like, stands for, and its name. Except for 0 the number of pliable bodies to make up each numeral is equal to the meaning of the numeral. For example, number 2 is made up of two pliable bodies, number 3 is made up of three pliable bodies, and so forth. When the child has acquired the skill of making each numeral from the pliable bodies, knowing their names and aligning them from 0 to 9, he or she is ready for the next major step of learning to count to 100. This step utilizes a jigsaw puzzle which has 10 elongate pieces that are -identical and numbered from top to bottom 1 to 9 followed by 0. Further elongate members are provided wherein one elongate member is plain with no numbers, another has nine 1's in a vertical column, and the others have the same numbers, starting with 2's and continuing to 9's, in vertical columns to match and be on the left side of the numbers 1-9 of the first set of pieces. To ensure that the second set of numbers are placed in the correct positions they have different distinct configurations to be received by a larger third piece. Each second set of numbers has vertically aligned thereunder on a fourth piece which is received along the bottom of the puzzle, a numeral next higher than the number on the second set. The left hand second piece has a 1 immediately thereunder. The second piece immediately to the right has a 2 vertically aligned with the nine 1's thereon and so forth so that the nine 9's on the right second piece have a 10 thereunder on the fourth piece. Thus when a child completes the puzzle, the numerals are aligned in groups of ten to count from 1 to 100. When the jigsaw puzzle is mastered by a student, a board or tablet providing numerals 1 to 100 may be substituted for the jigsaw puzzle. Boards of this type are well known and such boards or tablets showing the 1-100 table in ten horizontal rows and ten vertical columns may then be utilized as an introduction to addition, subtraction, multiplication and division. U.S. Pat. No. 1,400,887 to Liebman and U.S. Pat. No. 3,672,072 to Aklyama, disclose similar prior art boards. The instant board as well as prior art boards may be used for the purpose of introducing addition, subtraction, multiplication and division by counting by groups of numbers. The number involved can then be circled if on a tablet or taken away or turned upside down or otherwise identified if on a board. Inasmuch as the child now knows how to count, this should not be overly difficult. For example, if counting by twos, a marker or other indicia of one type or another would be used to mark or distinguish every even number. If starting with 1, then every odd number is marked. If by fives, the numbers would then be 5, 10, 15, 20, 25, 30, 35, 40, 45, 50, 55, 60, 65, 70; 75, 80, 85, 90, 95 and 100. Here the child also by counting learns how the numbers can be multiplied or divided. For example, if every fifth number starting with number 5 is distinguishable by starting at number 5 and counting four further distinguishable marks in order 10, 15, 20 and 25, it will be seen that 5×5=25 and 25÷5 =5. This can be and usually should be augmented by flash cards, blackboard exercises, and verbally. However, by these means the child is provided with a visual concept of the quantity, 25, that is what 5×5 represents. In other words, the answer, here 25, is consciously or subconsciously perceived to be logical and this perception, based on logic rather than memory, in turn is synergetic with memorization of the correct answer.

When the child has mastered the foregoing, he or she is ready to learn to count money. Here a board is provided with 100 pennies aligned vertically and horizontally in rows of ten each. In the left hand row, five pennies are shown to be the equivalent of a nickel and at the bottom thereof ten pennies are shown to be the equivalent of a dime, whereby it may also be ascertained that a dime has a value equal to two nickels. A quarter may also be outlined on the board by a square which takes in five pennies in five horizontal rows and five pennies in five vertical columns. From this it can be learned that the quarter is the same as twenty-five pennies or five nickels or two dimes and a nickel or three nickels and a dime. Further it can be shown that a total of one hundred pennies are the same as one dollar or as four quarters. From the standpoint of fractions it will be visually seen that one quarter is one-fourth of a dollar, a dime is one-tenth of a dollar and a nickel is one-twentieth of a dollar, as well as a penny being one-hundredth of a dollar. Again the student receives a visual representation of money and the board can be used for practical learning, making imaginary sales, paying for same, and calculating the change due back. The learning process is augmented by use of various senses such as visual, hearing and speaking and tactile. This is true not only of the board used for learning to count money, but also the other instruction paraphernalia discussed above.

Other objects, adaptabilities and capabilities of the invention will appear as the description progresses, reference being had to the accompanying drawings, in which:

### BRIEF DESCRIPTION OF THE DRAWINGS

FIG. 1 illustrates numerals 0 through 9 each comprised of a pliable body in accordance with the invention;

FIG. 2 shows a jigsaw puzzle to be used to teach students to count from 1 to 100, in accordance with the invention;

FIG. 3 shows a tablet for arithmetic exercises in accordance with the invention; and

FIG. 4 shows a table for teaching a student to handle money in accordance with the invention.

### DESCRIPTION OF THE PREFERRED EMBODIMENTS OF THE INVENTION:

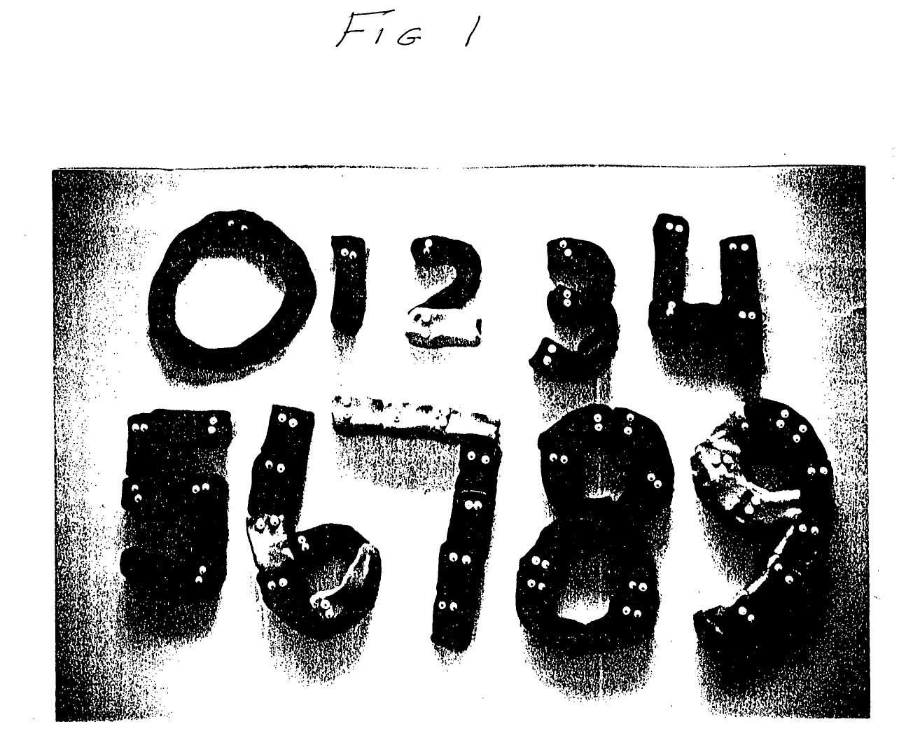

FIG. 1 shows the individual numbers 0 through 9 which are, except 0, composed of elongate pliable bodies, each of which has its own two eyes received in the pliable material (or combinations of materials) that are be used. For example, clay, parts of pipe cleaners, yarn or small elongate sacks filled with iron filings which are attracted to a magnetic underlying surface may be used. Each number consists of a number of such bodies which are equal to the number involved. For example, number 1 has only one body, whereas number 2 has two bodies, 3 has three bodies, and so forth. Each of the numerals has a different color or color scheme such as number 1 is blue, number 2 is blue and yellow, number 3 is blue, yellow and green, number 4 is blue, yellow, green and red, and so forth. The student uses a number of senses in the learning process including visual, verbalization, touch, etc. Also to augment the teaching process, a story is provided on how each of the numbers obtained its shape. Such a story, in Appendix 1 attached hereto, illustrates in more detail how this can be accomplished.

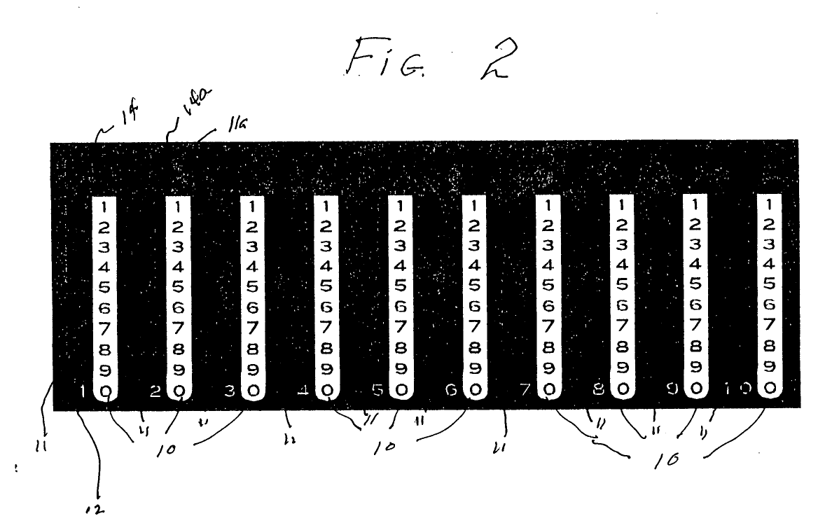

Once a student has mastered the numbers and is able to count from 0 to 10, both verbally and in writing, he or she is ready to learn to count to 100. Attention is invited to FIG. 2 which shows a jigsaw puzzle which can be used initially in an exercise for the student to put together whereby a table of 1 to 100 is created. It will be noted that there are ten vertically elongated first pieces 10 which are identical and have 1-9 with a 0 thereunder starting with 1 at the top and ending with 0 at the bottom. A further, second, set of elongated vertically disposed pieces 11 are also shown. Each piece fits against (on its left side) one of the first mentioned pieces. Also each second piece 11 has identical numbers aligned vertically thereon which horizontally match those on the neighboring first piece 10 to create numbers having two numerals. However, the first (left hand) such piece 11 does not have any numbers thereon, whereas those which do have numerals thereon are received thereafter from left to right by a progressively higher number that is commencing with 1 at the upper left ending at 99 on the lower right hand side, each piece has on its upper edge a different uniquely configured top 11a. A third top piece 14 has no numerals, but has cut out areas 14a which are all different to match and receive a corresponding the unique shape 11a of an elongate piece 11. On the bottom a horizontal fourth piece 12 is provided which receives the bottom portions of the two (first and second) vertically disposed pieces with the first such vertically disposed piece being lower and the horizontal fourth piece having a 1 to match with a 0 thereon, whereby at the bottom the numbers commence at 10, then 20, and so forth to 100 on the lower right. Each of the second elongate pieces 11 which are provided with the same numbers has a unique shape at its top so that if placed in the correct order, the progression of the resulting table from 1 to 100 automatically occurs. The method of teaching a student to count from 1 to 100 is set forth in more detail in Appendix 2.

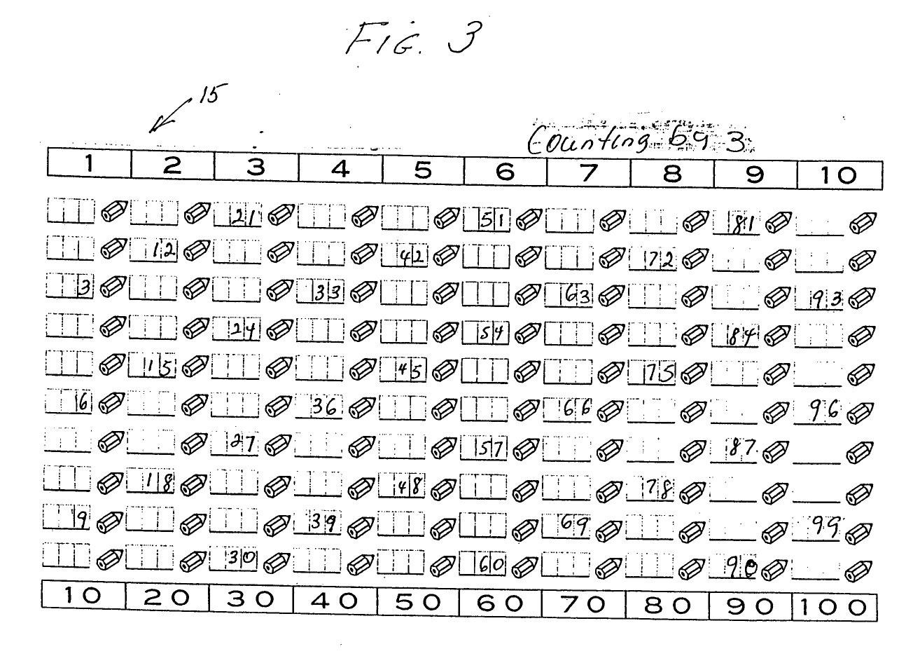

Once the student is familiar with the table represented by FIG. 2, a board to the same effect or a tablet 15 having such table printed thereon as shown in FIG. 3 can then be utilized. Boards which may be used, as previously indicated are disclosed in U.S. Pat. Nos. 1,400,887 and 3,672,672, which are incorporated herein by reference. A tablet can be the type wherein numbers are filled in adjacent the numbers in the table or a board can be used wherein various selective numbers can be distinguished by means, for example, of turning a number received in a square face down. Such boards, as recited above, are known. Appendix 3 hereof explains and illustrates in more detail how the tablet printout or board may be utilized for learning the four functions. The printed numeral 3 is utilized in Appendix 3 for illustration purposes. It will, however, be appreciated that almost any other number, up to and including 50, may be used. When counting by threes the student automatically advances three numbers for each count and from this can derive both multiples and divisions of numbers divided by three by simply counting the number of marked numbers from or to the identified multiple of three. For example, the number 18 has six three-multiples, to wit, 18, 15, 12, 9, 6 and 3, whereby it will be understood that 3×6=18 and 18÷6=3, or if 18 is divided by 3 the answer is 6.

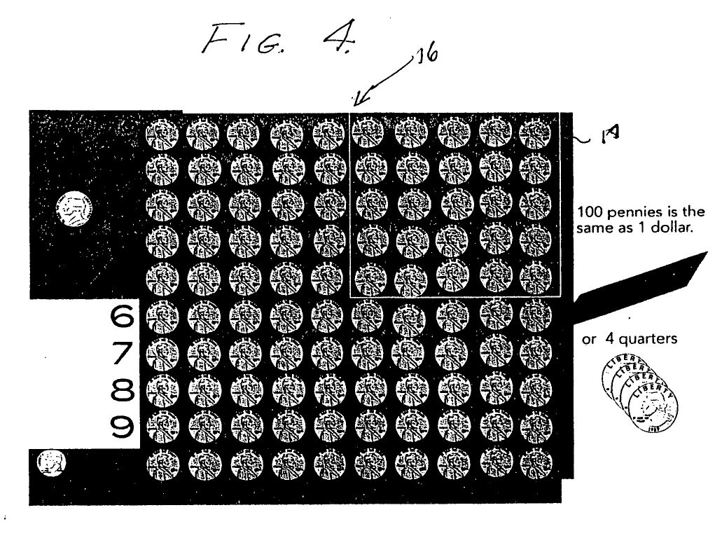

FIG. 4 is an illustration of a table to be used for learning to count money. Here it will be noted that a table with 100 circular depressions is provided for receiving 100 pennies. Each vertical column has ten pennies and each horizontal row also has ten pennies for a total of one hundred pennies. Thus as illustrated on FIG. 4, the table teaches that one hundred pennies are the same as one dollar. Also a nickel is indicated on the table to be equal to five pennies in the left hand column and ten pennies are indicated to be equal to a dime at the bottom of the same column. A quarter is also shown and delineated in a rectangle 17 to equal twenty-five pennies with five pennies in a row and five pennies in a column being within the outlined square 17. It is also stated that four quarters are the same as a dollar. Of course actual legal coins need not be used for the exercise, but the use of same in such exercises is likelier to have a longer lasting and practical effect than using play coins. It is contemplated that students or the teacher will use the board shown in FIG. 4 for make-believe sales of items. That is, the student will sell the item to the teacher and the teacher will make the payment at a greater amount than the actual price, whereby the student will have to make change. Or a student may purchase a make-believe item and then pay for same from the board money. In this connection, to make it more realistic, play dollars and half dollars might also be introduced.

It is contemplated that the teaching paraphernalia and methods set forth above and in the Appendices will be used in combination with flash card exercises as well as blackboard and verbal exercises. However, with the comprehension of the quantity that a particular number represents and its constituent make up, the student will acquire, consciously or subconsciously, an intuitive perception of what or about what the correct answer should be which reinforces the student's memorization learning process. It is, however, important that the instructor ensure that each student has mastered each step before proceeding to the next step. If this is accomplished, absent a learning disability, any child of normal intelligence should by the time that they become adults have sufficient mathematical capacity, for most types of employment.

The educational paraphernalia and methods described herein can also be incorporated in a computer by programming same on a DVD or floppy disk or other programmable media to be operated by an instructor or student, or both. Also games may be devised which will lead to the child's understanding of the algebraic equations. For example, numbers can be placed in a sequence with a question mark for the missing number, such as 40? 50, the missing number to be determined by the child being 10, or another sequence 2? 5, wherein the child identifies the missing number under the question mark as 3. For this purpose, cards with separate numbers such as shown in FIG. 1 may be utilized. They can also be utilized for addition, subtraction, multiplication and division. If the cards are numbered 0 to 100, then such exercises can be used in conjunction with exercises as described above utilizing the jigsaw puzzle of FIG. 2 or a table as shown in FIG. 3, or both. Instead of cards, cubes can be used, each cube having the same number of dots on each side or the same numeral on each side, or both, wherein the numeral indicates the number of dots. By rolling the dice or picking and choosing, or both, a student can utilize same for each arithmetic function. Thus if a cube with five dots or the numeral 5 thereon is placed with another cube with three dots with the numeral 3 thereon, the student can identify the difference as being 2 and the sum being 8. Where cubes having dots on them are used, the dots on different faces of the cube may be arranged in different dispositions whereby the student learns to recognize the number of dots that is identified by the numeral involved irrespective of how the dots may be disposed relative to each other. It will thus be recognized that an object of the invention is not only to acquaint the student with the fundamentals of arithmetic, but also, while doing so, to instill in the student an appreciation what the various numbers represent.

The material appended hereto is incorporated by reference in the Specification.

1. An apparatus which comprises each said plurality of pliable bodies which can be joined to represent the configuration of a number equal to the number of pliable bodies so joined.

2. An apparatus in accordance of claim 1, wherein each said body is provided with two eye-like features.

3. An apparatus in accordance with claim 1, wherein each said pliable body above the numeral 1 consists of at least two different colors.

4. A table of numbers 1 to 100 which comprises a jigsaw puzzle.

5. A table printed on a tablet which comprises numbers one through one hundred arranged in numerical order and marking means for marking selected of said numbers.

6. A table having depressions therein for one hundred individual one-cent pieces, at least one five-cent piece, at least one ten-cent piece and at least one twenty-five-cent piece, wherein twenty-five of said one-cent pieces are in a delineated square having five one-cent pieces in a horizontal row and five one-cent pieces in a vertical column.
